(19) United States
(12) Patent Application Publication
(10) Pub. No.: US 2009/0024449 A1
(43) Pub. Date: Jan. 22, 2009

(54) HABITUATION ANALYZER DEVICE UTILIZING CENTRAL NERVOUS SYSTEM, AUTONOMIC NERVOUS SYSTEM AND EFFECTOR SYSTEM MEASUREMENTS

(75) Inventors: Anantha Pradeep, Berkeley, CA (US); Robert T. Knight, Berkeley, CA (US); Ramachandran Gurumoorthy, Berkeley, CA (US)

Correspondence Address: BEYER WEAVER LLP, P.O. BOX 70250, OAKLAND, CA, 94612-0250, US

(73) Assignee: NEUROFOCUS INC., Berkeley, CA (US)

(21) Appl. No.: 12/122,240

(22) Filed: May 16, 2008

Related U.S. Application Data
(60) Provisional application No. 60/938,281, filed on May 16, 2007.

(51) Int. Cl. G06Q 30/00

(52) U.S. Cl. 705/10

(57) ABSTRACT

A system performs habituation analysis using central nervous system, autonomic nervous system, and effector data. Subjects are repeatedly exposed to stimulus material and data is collected using mechanisms such as Electroencephalography (EEG), Galvanic Skin Response (GSR), Electrocardiograms (EKG), Electrooculography (EOG), eye tracking, and facial emotion encoding. Data collected is analyzed to determine habituation and associated wear-out profiles for stimulus material.

### CROSS REFERENCE TO RELATED APPLICATIONS

This application claims priority to Provisional Patent Application 60/938,281 (Docket No. 2007NF5) titled Habituation Analyzer Device Utilizing Central Nervous System, Autonomic Nervous System And Effector System Measurements, by Anantha Pradeep, Robert T. Knight, and Ramachandran Gurumoorthy, and filed on May 16, 2007.

### TECHNICAL FIELD

The present disclosure relates to performing habituation analysis.

### DESCRIPTION OF RELATED ART

Conventional systems for performing habituation analysis and associated wear-out assessments of marketing and entertainment materials including advertising, audio clips, video streams, and other stimuli often rely on survey based evaluations to measure responses to repeated exposure to stimulus materials. According to various embodiments, a commercial is repeatedly presented to a user and survey results are taken after repeated presentations to assess habituation characteristics. However, existing mechanisms for performing habituation analysis are limited.

Consequently, it is desirable to provide improved methods and apparatus for performing habituation analysis.

### BRIEF DESCRIPTION OF THE DRAWINGS

The disclosure may best be understood by reference to the following description taken in conjunction with the accompanying drawings, which illustrate particular example embodiments.

FIG. 1 illustrates one example of a system for performing habituation analysis.

FIG. 2 illustrates one example of effectiveness data provided in relation to time.

FIG. 3 illustrates one example of effectiveness data provided after repeated exposure to stimulus.

FIG. 4 illustrates one example of a habituation profile.

FIG. 5 illustrates one example of a technique for performing habituation analysis.

FIG. 6 provides one example of a system that can be used to implement one or more mechanisms.

### DESCRIPTION OF PARTICULAR EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques and mechanisms of the present invention will be described in the context of particular types of central nervous system, autonomic nervous system, and effector data. However, it should be noted that the techniques and mechanisms of the present invention apply to a variety of different types of data. It should be noted that various mechanisms and techniques can be applied to any type of stimuli. In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

Overview

A system performs habituation analysis using central nervous system, autonomic nervous system, and effector data. Subjects are repeatedly exposed to stimulus material and data is collected using mechanisms such as Electroencephalography (EEG), Galvanic Skin Response (GSR), Electrocardiograms (EKG), Electrooculography (EOG), eye tracking, and facial emotion encoding. Data collected is analyzed to determine habituation and associated wear-out profiles for stimulus material.

### Example Embodiments

Conventional habituation analysis mechanisms rely on survey based data collected from subjects exposed to marketing materials. For example, subjects are required to complete surveys after initial and subsequent exposures to an advertisement. The survey responses are analyzed to determine possible patterns. However, survey results often provide only limited information on the habituation and associated wear-out characteristics of stimulus material. For example, survey subjects may be unable or unwilling to express their true thoughts and feelings about a topic, or questions may be phrased with built in bias. Articulate subjects may be given more weight than non-expressive ones. A variety of semantic, syntactic, metaphorical, cultural, social and interpretive biases and errors prevent accurate and repeatable evaluation. Responses from previous exposures have a non-trivial biasing of responses to current exposure.

Consequently, the techniques and mechanisms of the present invention use central nervous system, autonomic nervous system, and effector measurements to improve analysis of habituation and associated wear-out characteristics. Some examples of central nervous system measurement mechanisms include Functional Magnetic Resonance Imaging (fMRI) and Electroencephalography (EEG). fMRI measures blood oxygenation in the brain that correlates with increased neural activity. However, current implementations of fMRI have poor temporal resolution of few seconds. EEG measures electrical activity associated with post synaptic currents occurring in the milliseconds range. Subcranial EEG can measure electrical activity with the most accuracy, as the bone and dermal layers weaken transmission of a wide range of frequencies. Nonetheless, surface EEG provides a wealth of electrophysiological information if analyzed properly.

Autonomic nervous system measurement mechanisms include Galvanic Skin Response (GSR), Electrocardiograms (EKG), pupillary dilation, etc. Effector measurement mechanisms include Electrooculography (EOG), eye tracking, facial emotion encoding, reaction time, etc.

According to various embodiments, the techniques and mechanisms of the present invention intelligently blend multiple modes and manifestations of precognitive neural signatures with cognitive neural signatures and post cognitive neurophysiological manifestations to more accurately allow analysis of habituation to stimulus material. In some examples, autonomic nervous system measures are themselves used to validate central nervous system measures. Effector and behavior responses are blended and combined with other measures. According to various embodiments, central nervous system, autonomic nervous system, and effector system measurements are aggregated into a measurement that allows definitive evaluation of habituation characteristics of stimulus material over time. In some instances, it may be determined that stimulus material is effective only during a first viewing. In other examples, it may be determined that stimulus material is effective only after repeated viewings.

In particular embodiments, a subject is repeatedly exposed to stimulus material and central nervous system, autonomic nervous system, and effector data is collected during exposure. Response data collected during each exposure is analyzed to determine effectiveness measurements. According to various embodiments, effectiveness measurements are blended effectiveness measurements that include enhanced and/or combined measurements from multiple modalities. Effectiveness measurements may be provided with numerical values or may be graphically represented. Effectiveness measurements for various exposures are analyzed to determine possible patterns, fluctuations, profiles, etc., to provide habituation characteristics.

According to various embodiments, habituation characteristics may show an exponential decline in the effectiveness of stimulus material after a single exposure. In particular embodiments, habituation characteristics may show a linear decline in effectiveness before reaching a specific plateau. Habituation and associated wear-out characteristics can provide users with the ability to customize stimulus materials or customize presentation of stimulus materials to more effectively elicit desired responses.

A variety of stimulus materials such as entertainment and marketing materials, media streams, billboards, print advertisements, text streams, music, performances, sensory experiences, etc. can be analyzed. According to various embodiments, habituation characteristics are generated using a data analyzer that performs both intra-modality measurement enhancements and cross-modality measurement enhancements. According to various embodiments, brain activity is measured not just to determine the regions of activity, but to determine interactions and types of interactions between various regions. The techniques and mechanisms of the present invention recognize that interactions between neural regions support orchestrated and organized behavior. Attention, emotion, memory, and other abilities are not merely based on one part of the brain but instead rely on network interactions between brain regions.

The techniques and mechanisms of the present invention further recognize that different frequency bands used for multi-regional communication can be indicative of the effectiveness of stimuli. In particular embodiments, evaluations are calibrated to each subject and synchronized across subjects. In particular embodiments, templates are created for subjects to create a baseline for measuring pre and post stimulus differentials. According to various embodiments, stimulus generators are intelligent and adaptively modify specific parameters such as exposure length and duration for each subject being analyzed. An intelligent stimulus generation mechanism intelligently adapts output for particular users and purposes. A variety of modalities can be used including EEG, GSR, EKG, pupillary dilation, EOG, eye tracking, facial emotion encoding, reaction time, etc. Individual modalities such as EEG are enhanced by intelligently recognizing neural region communication pathways. Cross modality analysis is enhanced using a synthesis and analytical blending of central nervous system, autonomic nervous system, and effector signatures. Synthesis and analysis by mechanisms such as time and phase shifting, correlating, and validating intra-modal determinations allow generation of a composite output characterizing the significance of various data responses.

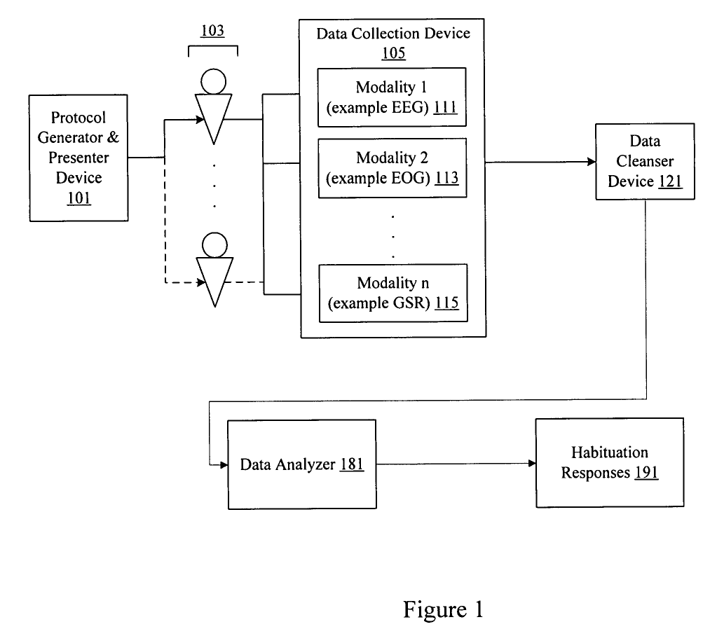

FIG. 1 illustrates one example of a system for performing habituation analysis using central nervous system, autonomic nervous system, and effector measures. According to various embodiments, the habituation analysis system includes a protocol generator and presenter device 101. In particular embodiments, the protocol generator and presenter device 101 is merely a presenter device and merely presents stimulus material to a user. The stimulus material may be a media clip, a commercial, pages of text, a brand image, a performance, a magazine advertisement, a movie, an audio presentation, particular tastes, smells, textures and/or sounds. The stimuli can involve a variety of senses and occur with or without human supervision. Continuous and discrete modes are supported. According to various embodiments, the protocol generator and presenter device 101 also has protocol generation capability to allow intelligent customization of stimuli provided to a subject.

According to various embodiments, the subjects are connected to data collection devices 105. The data collection devices 105 may include a variety of neurological and neurophysiological measurement mechanisms such as EEG, EOG, GSR, EKG, pupillary dilation, eye tracking, facial emotion encoding, and reaction time devices, etc. In particular embodiments, the data collection devices 105 include EEG 111, EOG 113, and GSR 115. In some instances, only a single data collection device is used. Data collection may proceed with or without human supervision.

The data collection device 105 collects neuro-physiological data from multiple sources. This includes a combination of devices such as central nervous system sources (EEG), autonomic nervous system sources (GSR, EKG, pupillary dilation), and effector sources (EOG, eye tracking, facial emotion encoding, reaction time). In particular embodiments, data collected is digitally sampled and stored for later analysis. In particular embodiments, the data collected could be analyzed in real-time. According to particular embodiments, the digital sampling rates are adaptively chosen based on the neurophysiological and neurological data being measured.

In one particular embodiment, the habituation analysis system includes EEG 111 measurements made using scalp level electrodes, EOG 113 measurements made using shielded electrodes to track eye data, GSR 115 measurements performed using a differential measurement system, a facial muscular measurement through shielded electrodes placed at specific locations on the face, and a facial affect graphic and video analyzer adaptively derived for each individual.

In particular embodiments, the data collection devices are clock synchronized with a protocol generator and presenter device 101. The data collection system 105 can collect data from a single individual (1 system), or can be modified to collect synchronized data from multiple individuals (N+1 system). The N+1 system may include multiple individuals synchronously tested in isolation or in a group setting. In particular embodiments, the data collection devices also include a condition evaluation subsystem that provides auto triggers, alerts and status monitoring and visualization components that continuously monitor the status of the subject, data being collected, and the data collection instruments. The condition evaluation subsystem may also present visual alerts and automatically trigger remedial actions.

According to various embodiments, the habituation analysis system also includes a data cleanser device 121. In particular embodiments, the data cleanser device 121 filters the collected data to remove noise, artifacts, and other irrelevant data using fixed and adaptive filtering, weighted averaging, advanced component extraction (like PCA, ICA), vector and component separation methods, etc. This device cleanses the data by removing both exogenous noise (where the source is outside the physiology of the subject) and endogenous artifacts (where the source could be neurophysiological like muscle movement, eye blinks, etc.).

The artifact removal subsystem includes mechanisms to selectively isolate and review the response data and identify epochs with time domain and/or frequency domain attributes that correspond to artifacts such as line frequency, eye blinks, and muscle movements. The artifact removal subsystem then cleanses the artifacts by either omitting these epochs, or by replacing these epoch data with an estimate based on the other clean data (for example, an EEG nearest neighbor weighted averaging approach).

According to various embodiments, the data cleanser device 121 is implemented using hardware, firmware, and/or software. It should be noted that although a data cleanser device 121 is shown located after a data collection device 105 and before data analyzer 181, the data cleanser device 121 like other components may have a location and functionality that varies based on system implementation. For example, some systems may not use any automated data cleanser device whatsoever while in other systems, data cleanser devices may be integrated into individual data collection devices.

The data cleanser device 121 passes data to the data analyzer 181. The data analyzer 181 uses a variety of mechanisms to analyze underlying data in the system to determine habituation and associated wear-out characteristics of stimulus material. According to various embodiments, the data analyzer customizes and extracts the independent neurological and neuro-physiological parameters for each individual in each modality, and blends the estimates within a modality as well as across modalities to elicit an enhanced response to the presented stimulus material. In particular embodiments, the data analyzer 181 aggregates the response measures across subjects in a dataset.

According to various embodiments, neurological and neuro-physiological signatures are measured using time domain analyses and frequency domain analyses. Such analyses use parameters that are common across individuals as well as parameters that are unique to each individual. The analyses could also include statistical parameter extraction and fuzzy logic based attribute estimation from both the time and frequency components of the synthesized response.

In some examples, statistical parameters used in a blended effectiveness estimate include evaluations of skew, peaks, first and second moments, population distribution, as well as fuzzy estimates of attention, emotional engagement and memory retention responses.

According to various embodiments, the data analyzer 181 may include an intra-modality response synthesizer and a cross-modality response synthesizer. In particular embodiments, the intra-modality response synthesizer is configured to customize and extract the independent neurological and neurophysiological parameters for each individual in each modality and blend the estimates within a modality analytically to elicit an enhanced response to the presented stimuli. In particular embodiments, the intra-modality response synthesizer also aggregates data from different subjects in a dataset.

According to various embodiments, the cross-modality response synthesizer or fusion device blends different intra-modality responses, including raw signals and signals output. The combination of signals enhances the measures of effectiveness within a modality. The cross-modality response fusion device can also aggregate data from different subjects in a dataset.

According to various embodiments, the data analyzer 181 also includes a composite enhanced effectiveness estimator (CEEE) that combines the enhanced responses and estimates from each modality to provide a blended estimate of the effectiveness. In particular embodiments, blended estimates are provided for each exposure of a subject to stimulus materials. The blended estimates are evaluated over time to determine habituation and associated wear-out characteristics. According to various embodiments, numerical values are assigned to each blended estimate. The numerical values may correspond to the intensity of neuro-feedback responses, the significance of peaks, the change between peaks, etc. Higher numerical values may correspond to higher significance in neuro-feedback intensity. Lower numerical values may correspond to lower significance or even insignificance neuro-feedback activity. In other examples, multiple values are assigned to each blended estimate. In still other examples, blended estimates of neuro-feedback significance are graphically represented to show changes after repeated exposure.

It may be determined that in some instances, stimulus material may only be effective during an initial exposure, with a significant drop-off in effectiveness after an initial exposure. In other examples, it may be determined that stimulus material elicits significance responses only after several repeated exposures. These habituation insights provide analysts with information on how to present stimulus materials for increased impact. In particular embodiments, the analysts use the habituation and associated wear-out measures for media buy optimization. Habituation measures can also be used to balance the reach and frequency components of media buy.

According to various embodiments, the data analyzer 181 provides effectiveness measurements to generate habituation and associated wear-out responses at 191. Habituation responses may be presented using a variety of mechanisms including numerical, graphical, text-based, etc. In particular embodiments, habituation responses are provided automatically to clients for input into media buy optimization algorithms. Habituation responses may be generated at 191, with components implemented using software, firmware, and/or hardware and may be generated with or without user input.

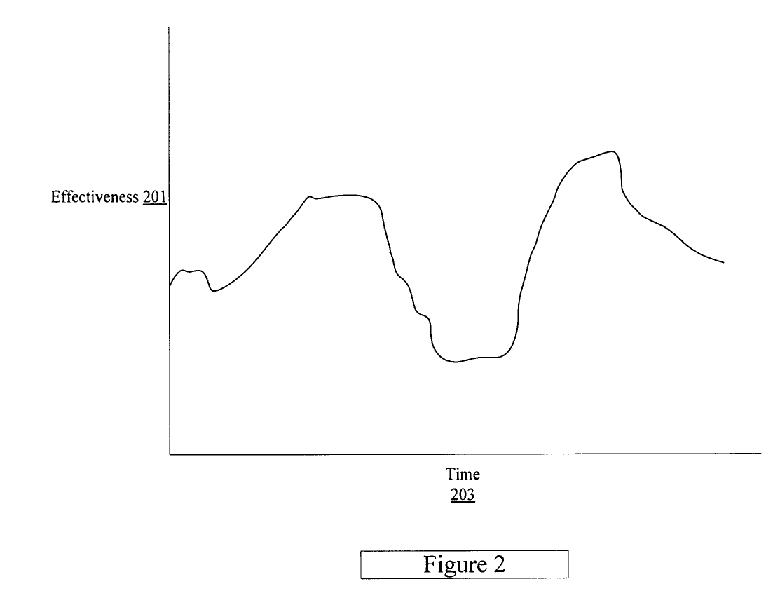

FIG. 2 illustrates one example of effectiveness data 201 provided in relation to time 203. According to various embodiments, effectiveness data 201 is generated using a data analyzer after a subject is exposed to stimulus material such as a media stream. In particular embodiments, the data analyzer processes underlying data in the system to determine effectiveness measures for the stimulus material. According to various embodiments, the data analyzer customizes and extracts the independent neurological and neuro-physiological parameters for each individual in each modality, and blends the estimates within a modality as well as across modalities to elicit an enhanced response to the presented stimulus material. In particular embodiments, the data analyzer aggregates the response measures across subjects in a dataset.

According to various embodiments, the effectiveness data 201 is processed to evaluate skew, peak significance, peak changes, rate of change, etc. In some examples, threshold values may be used to determine effectiveness values. A variety of mechanisms can be used to evaluate effectiveness.

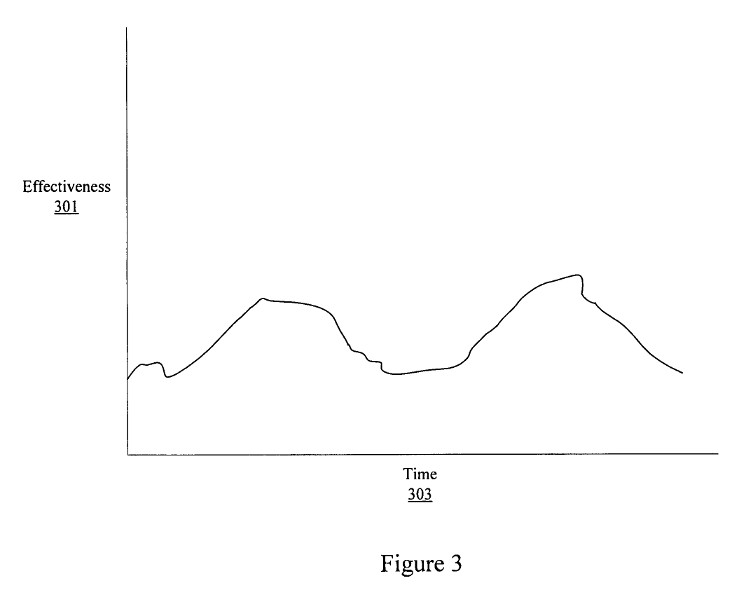

FIG. 3 illustrates one example of effectiveness data 301 provided in relation to time 303 after repeated exposure. According to various embodiments, a subject is repeatedly exposed to the same stimulus material. In other embodiments, a subject is continuously exposed to the same stimulus material. In still other embodiments, a subject is repeatedly exposed to similar but not identical stimulus material. According to various embodiments, an effectiveness graph is generated using combined, shifted, and aligned neurological and neurophysiological measures. In some examples, other data such as survey data can also be combined into an effectiveness graph. The effectiveness data 301 is graphed with respect to time 303 and skew, peak significance, peak changes, rate of change, etc., is evaluated. According to various embodiments, the effectiveness data 301 shows that the subject response to repeated exposure to stimulus material is more muted than an initial response shown using effectiveness data 201 in FIG. 2. It should be noted that other portions such as widely varying significance or low significance may also be identified in some examples.

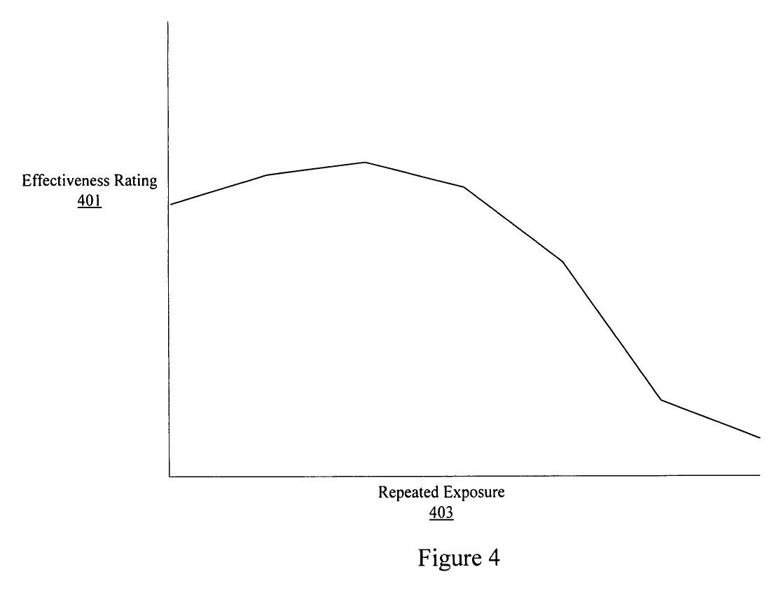

FIG. 4 illustrates one example of habituation characteristics derived from effectiveness data obtained during repeated exposure to stimulus materials. According to various embodiments, blended effectiveness ratings 401 are graphed in relation to the number of repeated exposures 403. In particular embodiments, after 1-4 exposures to stimulus material, effectiveness ratings 401 remain high. However, a significant drop-off in effectiveness is detected after continued exposure. In other examples, drop-offs occur in an exponential manner after an initial exposure. In other examples, the effectiveness could go up before starting to drop off or saturate.

According to various embodiments, time periods between exposures to stimulus material are varied and accounted for in a habituation profile. For example, an habituation analysis system may provide merely minutes between exposures to stimulus. In other examples, the habituation analysis system provides hours between exposures to stimulus. The time periods between exposures can be accounted for in a habituation profile or habituation characteristics table. The time periods between exposures may be varied automatically using a protocol generator and presenter device to provide additional insights to a user for media buy optimization.

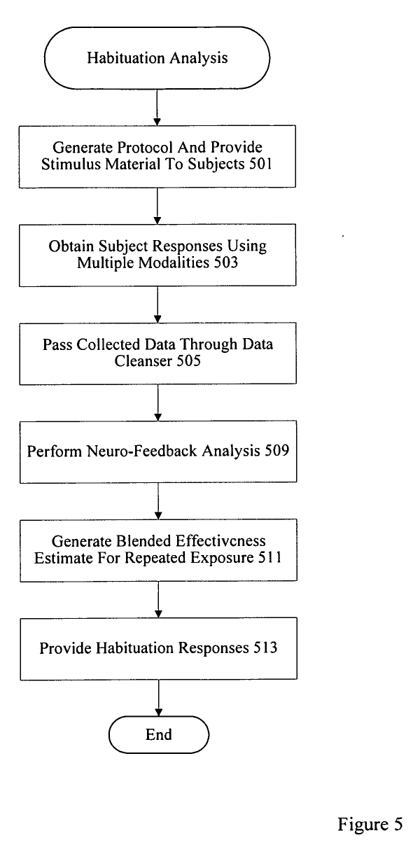

FIG. 5 illustrates one example of habituation analysis. At 501, a protocol is generated and stimulus material is provided to one or more subjects. According to various embodiments, stimulus includes streaming video, media clips, printed materials, presentations, performances, games, etc. The protocol determines the parameters surrounding the presentation of stimulus, such as the number of times shown, the duration of the exposure, sequence of exposure, segments of the stimulus to be shown, etc. Subjects may be isolated during exposure or may be presented materials in a group environment with or without supervision. At 503, subject responses are collected using a variety of modalities, such as EEG, ERP, EOG, GSR, etc. In some examples, verbal and written responses can also be collected and correlated with neurological and neurophysiological responses. At 505, data is passed through a data cleanser to remove noise and artifacts that may make data more difficult to interpret. According to various embodiments, the data cleanser removes EEG electrical activity associated with blinking and other endogenous/exogenous artifacts.

At 509, data analysis is performed. Data analysis may include intra-modality response synthesis and cross-modality response synthesis to enhance effectiveness measures. It should be noted that in some particular instances, one type of synthesis may be performed without performing other types of synthesis. For example, cross-modality response synthesis may be performed with or without intra-modality synthesis.

A variety of mechanisms can be used to generate blended effectiveness measures at 511. According to various embodiments, blended effectiveness measures are generated for each stimulus exposure. In other examples, blended effectiveness measures are generated periodically based on exposure times. In particular embodiments, EEG response data is synthesized to provide an enhanced assessment of effectiveness. According to various embodiments, EEG measures electrical activity resulting from thousands of simultaneous neural processes associated with different portions of the brain. EEG data can be classified in various bands. According to various embodiments, brainwave frequencies include delta, theta, alpha, beta, and gamma frequency ranges. Delta waves are classified as those less than 4 Hz and are prominent during deep sleep. Theta waves have frequencies between 3.5 to 7.5 Hz and are associated with memories, attention, emotions, and sensations. Theta waves are typically prominent during states of internal focus.

Alpha frequencies reside between 7.5 and 13 Hz and typically peak around 10 Hz. Alpha waves are prominent during states of relaxation. Beta waves have a frequency range between 14 and 30 Hz. Beta waves are prominent during states of motor control, long range synchronization between brain areas, analytical problem solving, judgment, and decision making. Gamma waves occur between 30 and 60 Hz and are involved in binding of different populations of neurons together into a network for the purpose of carrying out a certain cognitive or motor function, as well as in attention and memory. Because the skull and dermal layers attenuate waves in this frequency range, brain waves above 75-80 Hz are difficult to detect and are often not used for stimuli response assessment.

However, the techniques and mechanisms of the present invention recognize that analyzing high gamma band (kappa-band: Above 60 Hz) measurements, in addition to theta, alpha, beta, and low gamma band measurements, enhances neurological attention, emotional engagement and retention component estimates. In particular embodiments, EEG measurements including difficult to detect high gamma or kappa band measurements are obtained, enhanced, and evaluated. Subject and task specific signature sub-bands in the theta, alpha, beta, gamma and kappa bands are identified to provide enhanced response estimates. According to various embodiments, high gamma waves (kappa-band) above 80 Hz (typically detectable with sub-cranial EEG and/or magnetoencephalograophy) can be used in inverse model-based enhancement of the frequency responses to the stimuli.

Various embodiments of the present invention recognize that particular sub-bands within each frequency range have particular prominence during certain activities. A subset of the frequencies in a particular band is referred to herein as a sub-band. For example, a sub-band may include the 40-45 Hz range within the gamma band. In particular embodiments, multiple sub-bands within the different bands are selected while remaining frequencies are band pass filtered. In particular embodiments, multiple sub-band responses may be enhanced, while the remaining frequency responses may be attenuated.

An information theory based band-weighting model is used for adaptive extraction of selective dataset specific, subject specific, task specific bands to enhance the effectiveness measure. Adaptive extraction may be performed using fuzzy scaling. Stimuli can be presented and enhanced measurements determined multiple times to determine the variation or habituation profiles across multiple presentations. Determining the variation and/or habituation profiles provides an enhanced assessment of the primary responses as well as the longevity (wear-out) of the marketing and entertainment stimuli. The synchronous response of multiple individuals to stimuli presented in concert is measured to determine an enhanced across subject synchrony measure of effectiveness. According to various embodiments, the synchronous response may be determined for multiple subjects residing in separate locations or for multiple subjects residing in the same location.

Although a variety of synthesis mechanisms are described, it should be recognized that any number of mechanisms can be applied—in sequence or in parallel with or without interaction between the mechanisms.

Although intra-modality synthesis mechanisms provide enhanced significance data, additional cross-modality synthesis mechanisms can also be applied. A variety of mechanisms such as EEG, Eye Tracking, GSR, EOG, and facial emotion encoding are connected to a cross-modality synthesis mechanism. Other mechanisms as well as variations and enhancements on existing mechanisms may also be included. According to various embodiments, data from a specific modality can be enhanced using data from one or more other modalities. In particular embodiments, EEG typically makes frequency measurements in different bands like alpha, beta and gamma to provide estimates of significance. However, the techniques of the present invention recognize that significance measures can be enhanced further using information from other modalities.

For example, facial emotion encoding measures can be used to enhance the valence of the EEG emotional engagement measure. EOG and eye tracking saccadic measures of object entities can be used to enhance the EEG estimates of significance including but not limited to attention, emotional engagement, and memory retention. According to various embodiments, a cross-modality synthesis mechanism performs time and phase shifting of data to allow data from different modalities to align. In some examples, it is recognized that an EEG response will often occur hundreds of milliseconds before a facial emotion measurement changes. Correlations can be drawn and time and phase shifts made on an individual as well as a group basis. In other examples, saccadic eye movements may be determined as occurring before and after particular EEG responses. According to various embodiments, time corrected GSR measures are used to scale and enhance the EEG estimates of significance including attention, emotional engagement and memory retention measures.

Evidence of the occurrence or non-occurrence of specific time domain difference event-related potential components (like the DERP) in specific regions correlates with subject responsiveness to specific stimulus. According to various embodiments, ERP measures are enhanced using EEG time-frequency measures (ERPSP) in response to the presentation of the marketing and entertainment stimuli. Specific portions are extracted and isolated to identify ERP, DERP and ERPSP analyses to perform. In particular embodiments, an EEG frequency estimation of attention, emotion and memory retention (ERPSP) is used as a co-factor in enhancing the ERP, DERP and time-domain response analysis.

EOG measures saccades to determine the presence of attention to specific objects of stimulus. Eye tracking measures the subject's gaze path, location and dwell on specific objects of stimulus. According to various embodiments, EOG and eye tracking is enhanced by measuring the presence of lambda waves (a neurophysiological index of saccade effectiveness) in the ongoing EEG in the occipital and extra striate regions, triggered by the slope of saccade-onset to estimate the significance of the EOG and eye tracking measures. In particular embodiments, specific EEG signatures of activity such as slow potential shifts and measures of coherence in time-frequency responses at the Frontal Eye Field (FEF) regions that preceded saccade-onset are measured to enhance the effectiveness of the saccadic activity data.

GSR typically measures the change in general arousal in response to stimulus presented. According to various embodiments, GSR is enhanced by correlating EEG/ERP responses and the GSR measurement to get an enhanced estimate of subject engagement. The GSR latency baselines are used in constructing a time-corrected GSR response to the stimulus. The time-corrected GSR response is co-factored with the EEG measures to enhance GSR significance measures.

According to various embodiments, facial emotion encoding uses templates generated by measuring facial muscle positions and movements of individuals expressing various emotions prior to the testing session. These individual specific facial emotion encoding templates are matched with the individual responses to identify subject emotional response. In particular embodiments, these facial emotion encoding measurements are enhanced by evaluating inter-hemispherical asymmetries in EEG responses in specific frequency bands and measuring frequency band interactions. The techniques of the present invention recognize that not only are particular frequency bands significant in EEG responses, but particular frequency bands used for communication between particular areas of the brain are significant. Consequently, these EEG responses enhance the EMG, graphic and video based facial emotion identification.

At 513, habituation characteristics or a habituation profile is provided using effectiveness estimates. A habituation profile may provide information to implement a media buy strategy.

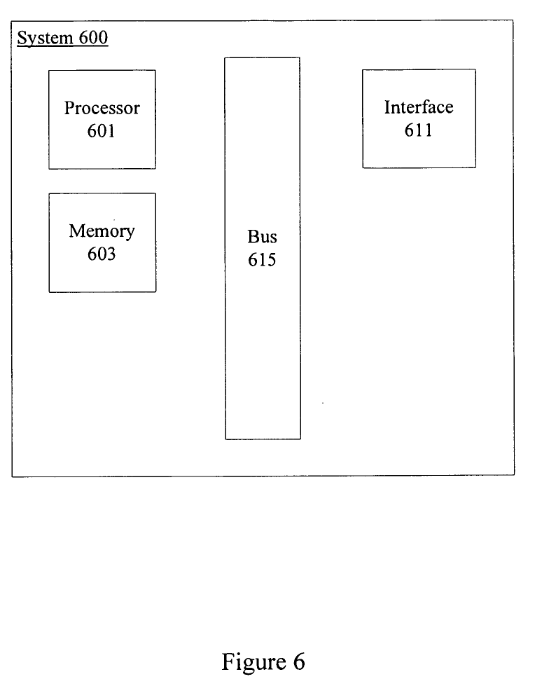

According to various embodiments, various mechanisms such as the data collection mechanisms, the intra-modality synthesis mechanisms, cross-modality synthesis mechanisms, etc. are implemented on multiple devices. However, it is also possible that the various mechanisms be implemented in hardware, firmware, and/or software in a single system. FIG. 6 provides one example of a system that can be used to implement one or more mechanisms. For example, the system shown in FIG. 6 may be used to implement a data cleanser device or a cross-modality responses synthesis device.

According to particular example embodiments, a system 600 suitable for implementing particular embodiments of the present invention includes a processor 601, a memory 603, an interface 611, and a bus 615 (e.g., a PCI bus). When acting under the control of appropriate software or firmware, the processor 601 is responsible for such tasks such as pattern generation. Various specially configured devices can also be used in place of a processor 601 or in addition to processor 601. The complete implementation can also be done in custom hardware. The interface 611 is typically configured to send and receive data packets or data segments over a network. Particular examples of interfaces the device supports include host bus adapter (HBA) interfaces, Ethernet interfaces, frame relay interfaces, cable interfaces, DSL interfaces, token ring interfaces, and the like.

In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as data synthesis.

According to particular example embodiments, the system 600 uses memory 603 to store data, algorithms and program instructions. The program instructions may control the operation of an operating system and/or one or more applications, for example. The memory or memories may also be configured to store received data and process received data.

Because such information and program instructions may be employed to implement the systems/methods described herein, the present invention relates to tangible, machine readable media that include program instructions, state information, etc. for performing various operations described herein. Examples of machine-readable media include, but are not limited to, magnetic media such as hard disks, floppy disks, and magnetic tape; optical media such as CD-ROM disks and DVDs; magneto-optical media such as optical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

Although the foregoing invention has been described in some detail for purposes of clarity of understanding, it will be apparent that certain changes and modifications may be practiced within the scope of the appended claims. Therefore, the present embodiments are to be considered as illustrative and not restrictive and the invention is not to be limited to the details given herein, but may be modified within the scope and equivalents of the appended claims.

What is claimed is:

1. A method, comprising:
repeatedly exposing a subject to stimulus material;
collecting response data from the subject repeatedly exposed to stimulus material, the response data including central nervous system and effector data;
analyzing the response data collected from the subject to generate a habituation profile for the subject, wherein analyzing the response data comprises determining the effectiveness of the stimulus material at various times during repeated exposure.

2. The method of claim 1, wherein the response data further includes autonomic nervous system data.

3. The method of claim 1, wherein effectiveness is determined using neurological and neurophysiological measurements including attention, emotion, and memory retention.

4. The method of claim 1, wherein effectiveness is determined using combinations of neurological and neurophysiological measurements including attention, emotion, and memory retention.

5. The method of claim 1, wherein response data includes neurological and neurophysiological response data.

6. The method of claim 1, wherein the stimulus material is an advertisement stream.

7. The method of claim 6, wherein the response data is used to generate the habituation and associated wear-out profile.

8. The method of claim 1, wherein the stimulus material is a motion picture or trailer.

9. The method of claim 1, wherein the stimulus material is a print advertisement.

10. The method of claim 1, wherein the stimulus material is marketing or entertainment material

11. The method of claim 1, wherein effectiveness is determined further using survey responses.

12. The method of claim 1, wherein the habituation profile is used to implement a media-buy strategy.

13. The method of claim 1, wherein habituation profiles are obtained for a plurality of subjects.

14. The method of claim 13, wherein a habituation profile is obtained for a group using the habituation profiles from the plurality of subjects.

15. A system, comprising:
a presenter device operable to repeated expose a subject to stimulus material;
a data collector device operable to obtain response data from the subject repeatedly exposed to stimulus material, the response data including central nervous system and effector data;
a data analyzer operable to analyze the response data collected from the subject to generate a habituation profile for the subject, wherein analyzing the response data comprises determining the effectiveness of the stimulus material at various times during repeated exposure.

16. The system of claim 15, wherein the response data further includes autonomic nervous system data.

17. The system of claim 15, wherein effectiveness is determined using neurological and neurophysiological measurements including attention, emotion, and memory retention.

18. The system of claim 15, wherein effectiveness is determined using combinations of neurological and neurophysiological measurements including attention, emotion, and memory retention.

19. The system of claim 15, wherein response data includes neurological and neurophysiological response data.

20. The system of claim 15, wherein the stimulus material is an advertisement stream.

21. The system of claim 20, wherein the response data is used to generate the habituation and associated wear-out profile.

22. An apparatus, comprising:
means for repeatedly exposing a subject to stimulus material;
means for collecting response data from the subject repeatedly exposed to stimulus material, the response data including central nervous system and effector data;
means for analyzing the response data collected from the subject to generate a habituation profile for the subject, wherein analyzing the response data comprises determining the effectiveness of the stimulus material at various times during repeated exposure.

23. The apparatus of claim 22, wherein the response data further includes autonomic nervous system data.
